(19) United States
(12) Patent Application Publication
(10) Pub. No.: US 2006/0252468 A1
(43) Pub. Date: Nov. 9, 2006

(54) Extended-life locator feature for cordless handsets

(76) Inventor: Jonathan Whitman, Baltimore, MD (US)

Correspondence Address: OBER | KALER;c/o Royal W. Craig, 120 East Baltimore Street, Baltimore, MD, 21202, US

(21) Appl. No.: 11/408,156

(22) Filed: Apr. 20, 2006

Related U.S. Application Data
(60) Provisional application No. 60/673,167, filed on Apr. 20, 2005.

(51) Int. Cl. H04B 1/38; H04M 1/00

(52) U.S. Cl. 455/574; 379/428.02

(57) ABSTRACT

A cordless telephone handset having a long-life locator feature that survives even after the main handset battery drains. The cordless handset includes a first circuit board for all telephonic communication circuitry, and an independent second circuit board dedicated to the handset locator circuitry. The second circuit board includes an RF receiver for receiving an RF locator signal from the cordless telephone base when a handset locator key is depressed, and a lithium-ion battery for powering the dedicated RF locator-receiver. In addition, the dedicated RF locator-receiver is an ASK (Amplitude Shift Key) receiver that relies on a transmission signal to “wake-up”, otherwise keeping in standby mode to further conserve battery life. Under normal use the locator feature of the present invention will last years, rather than days.

### CROSS-REFERENCE TO RELATRED APPLICATIONS

The present application derives priority from U.S. Provisional application No. 60/673,167 filed Apr. 20, 2005.

### BACKGROUND OF THE INVENTION

1. Field of the Invention

The present invention relates to cordless telephones and, more particularly, to a cordless handset electronics layout with a dedicated locator circuit board and lithium ion battery for extended-operating life.

2. Description of the Background

Remote control units, such as remotes for televisions, stereos, telephones, VCR's, etc., have become extremely prevalent. Users of these remote units tend to misplace them and forget where they are, or they may become lost under sofa cushions or the like. This problem is most acute for cordless phones, where the problem typically arises when the phone is ringing. A great deal of valuable time has been spent searching for misplaced remote units.

There have been prior efforts to provide locator features to help locate commonly misplaced objects. For example, U.S. Pat. No. 4,101,873 to Anderson et al. issued Jul. 18, 1978 shows a miniaturized coded transmitter and battery powered receiver. When the receiver is interrogated by the transmitter it will respond audibly. By placing such receivers on commonly used objects such as eyeglasses, purses and other personal articles, audible location of these articles is accomplished by interrogating each object with a corresponding coded signal and following the audible response from the object to the position of the object to locate the latter.

The duty cycle of the receiver is very short and recurrent over intervals less than the known energization interval of the transmitter to insure reception but materially minimize the power consumption of the receivers.

The problem has been confronted with cordless handsets as well. For example, U.S. Pat. No. 5,952,918 by Ohayon issued Sep. 14, 1999 shows a feature for locating and recovering a misplaced handset using a locator adapted to produce audible musical signals such that location and recovery of the remote unit may be obtained.

Subsequent efforts include the following.

U.S. Pat. No. 5,805,999 issued on Sep. 8, 1998 to Inoue discloses a method for estimating the location of a cordless phone in a cordless phone system. Each base station transmits a signal including its own identification code. A cordless phone generates a plurality of pair information corresponding to an identification code to a detected reception level based on a signal from each base station. The cordless phone also selects pair information having the largest reception level from among the pair information, and estimates a base station based on the pair information corresponding to the selected reception level.

U.S. Pat. No. 6,353,413 issued to White et al. on Mar. 5, 2002 discloses a multifunction universal controller and locator systems. A controller communicates with a first set of devices and a second set of devices. The controller includes a transmitter for transmitting commands to remotely control the first set of devices, and for communicating input/output (I/O) data with the second set of devices. The controller contains cellular and cordless phone circuitry which provide the controller with phone and paging capabilities. The spatial location of the target object is determined with reference to a predetermined spatial reference point based on measured elapsed times.

U.S. Patent Application No. 20020102974 issued on Aug. 1, 2002 to Raith, Alex Krister discloses a method for mating a mobile terminal with a cordless phone system. A mobile terminal includes a primary transceiver to communicate with a mobile communication network and a secondary transceiver to communicate with a base unit of a cordless telephone system. When the mobile terminal is out of range of the base unit, it searches or listens for the base unit at a predetermined searching or listening frequency. The searching or listening frequency is dependent upon the distance of the mobile terminal from the base unit. A threshold is also established beyond which the mobile terminal may discontinue searching or listening for the base unit to conserve battery power or, alternatively, set the searching or listening frequency to a minimum value.

U.S. Patent Application No. 20010029187 issued on Oct. 11, 2001 to Cannon, Joseph M., et al. discloses an adaptive paging signal in a cordless phone. In one embodiment of the invention, a cordless phone includes a base unit, including a paging mechanism, and a handset, including an alerting mechanism responsive to the paging mechanism. At least one of the base unit and the handset includes a page adjusting mechanism to affect an alerting signal output from the alerting mechanism based on a condition. The paging signal allows the user to determine the location of a misplaced handset. In another embodiment, the base unit can provide an indication related to a distance between the base unit and the handset.

The above-described cordless locator features have proven so helpful that virtually all cordless telephone manufacturers include it as a standard feature. Unfortunately, they have all done so in the most economical way, which typically entails only an additional “page” or “locator” button on both base unit and cordless handset. The locator feature in the handset shares the same circuit board as the communication circuitry, the same transceiver, the same speaker, and the same battery. For example, both the Panasonic KX-TG2322B and KX-TG2313W cordless phones have handsets with their own NiMH battery used by all circuitry. This becomes a problem because most cordless handsets only have a two to three-day standby time before the main battery is depleted. Thus, after two to three days the main battery drains, the locator feature becomes disabled, and the user becomes frustrated, typically believing that the cordless handset was lost somewhere else. They stop looking.

It would be greatly advantageous to provide a long-life cordless handset locator feature. This same goal is apparent in the '873 patent to Anderson et al. (described above), where the cordless handset intermittently “polls” the base unit to see if the locator button is depressed. This intermittent operation conserves battery life. However, it is believed that the goal can be accomplished more efficiently by a totally separate locator architecture built into the handset: one that is separate and distinct from the main circuit board.

Accordingly, there is a significant demand for an extended-life locator feature for cordless handsets that employs an independent architecture and battery, separate from the main circuit board.

### SUMMARY OF THE INVENTION

It is, therefore, an object of the present invention to provide a long-life handset locator feature for cordless handsets and other wireless electronic devices that employs a fully or partially-independent architecture and/or battery, separate from the main handset circuit board, so as to provide an operational lifetime measured in years rather than days.

These and other objects are accomplished by the present invention, which is a long-life handset locator feature for cordless handsets in which three distinct aspects are combined to allow a much longer locator functionality, whereby the locator feature survives even after the main battery drains. The cordless telephone handset may be used in conjunction with any cordless telephone base having a keypad that includes a handset locator key. The cordless handset includes a first circuit board for all telephonic communication circuitry (voice receiver for receiving voice communication signals from the cordless telephone base unit and a rechargeable battery for powering the voice receiver). In addition, an independent second circuit board is provided for handset locator circuitry, the second circuit board including an RF receiver for receiving an RF locator signal from said cordless telephone base when the handset locator key is depressed, and a lithium-ion battery for powering the dedicated RF locator-receiver. In addition, the dedicated RF locator-receiver is an ASK (Amplitude Shift Key) receiver that relies on a transmission signal to “wake-up”, otherwise keeping in standby mode to further conserve battery life. Under normal use the locator feature of the present invention, when paired with a long-life lithium ion or similar battery, will last years will last years rather than days.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a block diagram of the cordless handset with dedicated locator circuit board and battery for extended-operating life according to the present invention.

FIG. 2 is a schematic block diagram of an 433-MHz FM transmitter circuit for the locator pager 26.

FIG. 3 is schematic block diagram a suitable associated receiver 18.

### DETAILED DESCRIPTION OF THE PREFERRED EMBODIMENTS

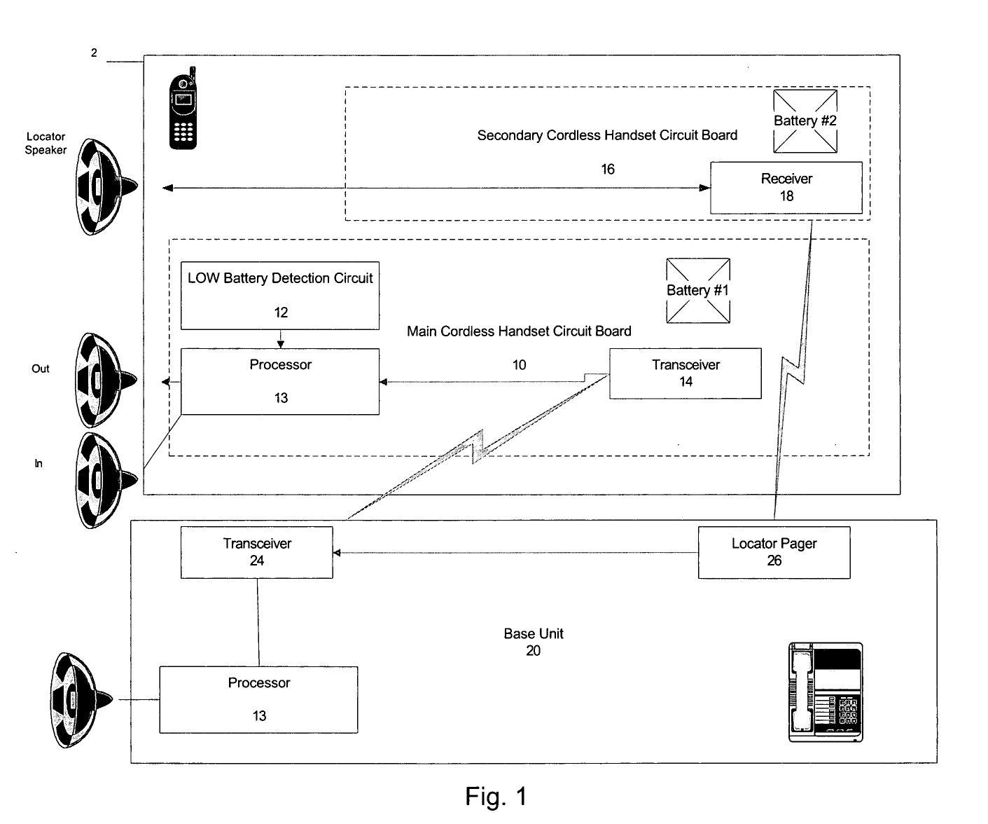

Referring to FIG. 1, the present invention is a cordless handset 2 with dedicated locator circuit board 16 and battery #2 for extended the operating lifetime of the locator feature.

The cordless handset 2 is configured to operate compatibly with a conventional wireless base unit 20 which may be any conventional unit, for example, a 2.4 Ghz spread spectrum cordless phone system. A spread spectrum system switches rapidly from one frequency to the next. The choice of the next frequency is random, so it is nearly impossible for someone to eavesdrop or jam the signal.

The basic components of the base unit 20 include a transceiver 24 and a processor 13 (both conventional components), and a locator pager 26. Base unit 20 also includes a user input unit such as a keypad (not shown), via which a user may initiate the page function of locator pager 26, such as by pressing a particular key of the keypad. Base unit 20 further includes a telephone line interface for coupling to a telephone line. The transceiver 24 transmits via an antenna for RF communication with the transceiver 14 of cordless handset 2. Similarly, the locator/pager 26 transmits via an antenna for RF communication with the receiver 18 of cordless handset 2. All transmissions are RF, and one skilled in the art will readily recognize that the hardware of the transceiver 24 and locator/pager 26 may be combined, though the functions are quite distinct. The details of RF communication protocols between base unit 20 and handset 2 of the cordless telephone is well known to those of skill in the art and will not be discussed herein in detail. The base unit 20 may include a speaker as shown for speakerphone operation without the cordless handset 2.

Cordless handset 2 also includes a user input such as a keypad, a microphone (in) and speaker (out), and a processor 13 coupled to transceiver 14. These elements are typically all contained on a primary circuit board 10 powered by a conventional NiCad rechargeable Battery #1. A low battery detection circuit 12 may be provided for convenience, and these will typically emit a beeping sound through the output speaker when a low battery condition is detected. The foregoing components also function primarily in conventional ways that are well known to those of ordinary skill in the art, and these traditional functions will not be discussed in detail.

In accordance with the present invention, a Secondary Cordless Handset Circuit Board 16 is provided and this includes the receiver 18 powered by a secondary Battery #2. Battery #2 is preferably a circuit-board mounted lithium ion battery dedicated to powering the receiver 18. The receiver 18 may be any conventional RF receiver configured for receiving a page signal from the locator pager 26 in the base unit 20. However, it is preferred that the receiver be an ASK receiver for reception in the 315-434 Mhz range. An ASK (Amplitude Shift Key) receiver does not require a carrier signal to be is present, but instead relies on the transmission signal to “wake-up” the receiver circuit. A suitable ASK transmitter for the locator pager 26 in the base unit 20 as well as an ASK receiver 18 is available from Laipac Technology Inc. under their TLP/RLP Series. The typical range is 500 ft for open areas, and there are 433.92 Mhz, 418 Mhz and 315 Mhz available.

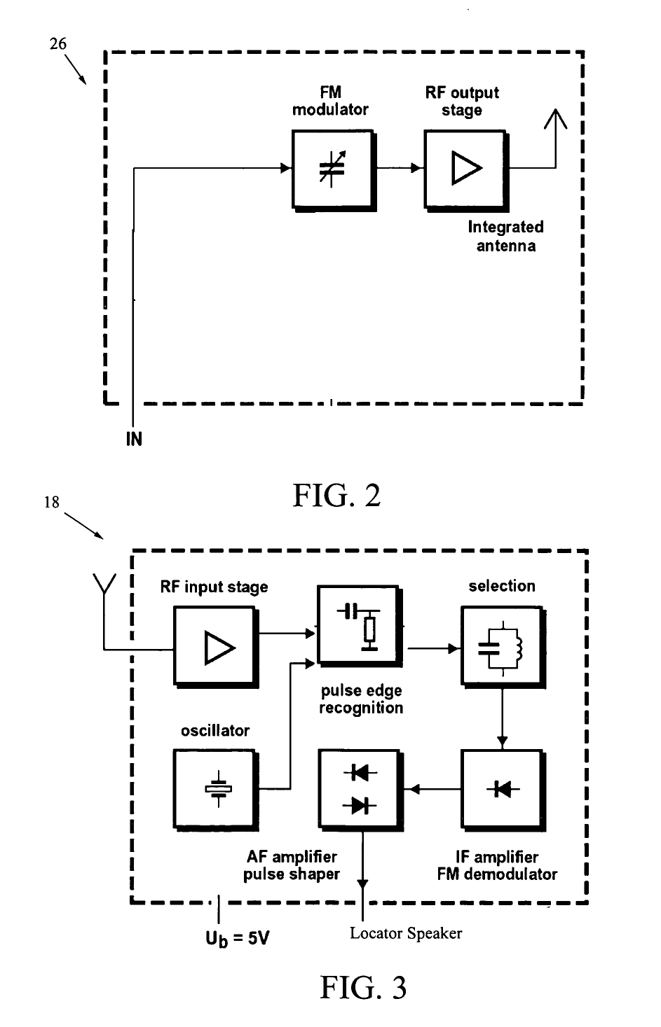

FIG. 2 is a schematic block diagram of an 433-MHz FM transmitter circuit for the locator pager 26, and FIG. 3 is schematic block diagram a suitable associated receiver 18. The locator pager 26 (FIG. 2) is a very simple superheterodyne design for broadcasting a simple pulse train upon someone depressing the locator button on the base unit 20. The associated receiver 18 actuates automatically by means of pulse edge detection, as soon as data pulses are detected at the input. When the data signal is removed, the receiver 18 automatically returns to standby mode after about 200 ms.

Thus, in operation, when the handset 2 is not coupled to base unit 20, and is misplaced, the user activates the page function by, for example, pressing a PAGE key on the keypad of the base unit 20. The locator pager 26 broadcasts a PAGE pulse train that wakes up the associated receiver 18 by pulse edge detection, and receiver 18 outputs an audible beeping signal through the locator speaker of the handset 2. Three characteristics of the above-described device combine to allow a much longer locator functionality: 1) the locator receiver 18 and secondary Battery #2 that powers it are independent of the main circuit board in the handset 2, and thus Battery #2 is not depleted by day-to-day calling operations; 2) Battery #2 is a long-life lithium ion battery; 3) the receiver 18 is a “wake-on-demand” circuit that automatically returns to standby mode, thereby conserving battery life. Indeed, under normal use the locator feature of the present invention will last years, rather than days.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A cordless telephone handset for use in conjunction with a cordless telephone base having a keypad that includes a handset locator key, the handset comprising:
a first circuit board on which telephonic communication circuitry resides, said telephonic communication circuitry including a first receiver for receiving voice communication signals from said cordless telephone base and a first battery for powering said first receiver; and
a second circuit board on which handset locator circuitry resides, said second circuit board including a second receiver for receiving an RF signal from said cordless telephone base when said handset locator key is depressed, and a second lithium ion battery for powering said second receiver.

2. The cordless telephone handset according to claim 1, wherein said second receiver is an ASK (Amplitude Shift Key) receiver that relies on a transmission signal to “wake-up”.
